(19) United States
(12) Patent Application Publication
(10) Pub. No.: US 2007/0059859 A1
(43) Pub. Date: Mar. 15, 2007

(54) Hydrogen reservoir based on silicon nano-structures

(76) Inventors: Volodymyr Lysenko, Villeurbanne (FR); Christophe Jean-Paul Philippe Turpin, Toulouse (FR)

Correspondence Address: HUTCHISON LAW GROUP PLLC, PO BOX 31686, RALEIGH, NC, 27612, US

(21) Appl. No.: 10/566,041

(22) PCT Filed: Jul. 27, 2004
(86) PCT No.: PCT/FR04/50358

§ 371 Date: Oct. 13, 2006

(30) Foreign Application Priority Data
Jul. 28, 2003 (FR) 0350375

(51) Int. Cl. H01L 51/40

(52) U.S. Cl. 438/99; 977/721; 977/786

(57) ABSTRACT

The invention relates to a hydrogen reservoir comprising a substance suitable for storing hydrogen wherein said substance is made up of nano-structured silicon. It also relates to a process for manufacturing and a method for use of this hydrogen reservoir.

### TECHNICAL FIELD

This invention relates to a hydrogen reservoir, at atmospheric pressure, with a base of silicon nano-structures. It is applicable in particular to the field of fuel cells (nano-, micro- and macro-cells). It can also be applied to the field of hydrogen motors (nano-, micro- and macro-motors).

### STATE OF PRIOR ART

Hydrogen is currently a very highly prospective energy vector. Its storage constitutes one of the crucial points in the development of fuel cells, whatever-the application, or of reduced-size devices.

Storage of hydrogen in cryogenic reservoirs or under pressure is known. These solutions are not compatible, or reasonably conceivable, in certain fields and in particular for portable devices (telephones, computers, small electronic devices). This statement is valid to a lesser degree in the field of ground transport. As a matter of fact, it is not easy to construct reservoirs under the very high pressures (greater than 500 bars) necessary in order to have sufficient autonomy. Moreover, storage under very high pressure clearly poses the problem of safety. As to the cryogenic solutions, they are put at a disadvantage by the poor yield of the hydrogen liquefaction process.

For all types of applications, numerous manufacturers are trying to circumvent the difficulties of the storage of pure hydrogen by using intermediate fuels (methanol, natural gas, hydrocarbons, etc.) that require a reforming operation for local extraction of the hydrogen. Reforming of intermediate fuels principally raises the problem of pollution (emission of carbon dioxide) and the problem of the overall energy yield of the system. Moreover, it seems, as far as methanol is concerned, that steps are going to be taken in Europe to limit its use in view of its toxicity with respect to the water tables among others.

Industrially, storage of hydrogen at atmospheric pressure is possible in reservoirs using solid metallic hydrides. These materials offer a priori interesting prospects but they have the drawback of their low mass energy.

In a more futuristic way, work is currently being conducted on the storage of hydrogen in carbon nanotubes. In spite of the very promising prospects of carbon nanotubes, the problem of their mass manufacture remains to be resolved.

Generally speaking, as far as hydrogen storage is concerned, the following document can be referred to: “Hydrogen Storage,” MRS Bulletin, volume 27, No. 9, September 2002, pages 675 to 716.

Hydrogen is increasingly being considered as an interesting solution as an energy source in the context of lasting development and entry into an era of growing scarcity of fossil and fissionable fuels.

Moreover, it has been observed that meso-porous and nano-porous silicon nano-structures are capable of retaining hydrogen at atmospheric pressure, in the form of Si-Hₓ bonds (x being able to take the values of 1, 2 or 3) following contact with absolution of hydrofluoric acid used during an anodisation process. However, no experimental measurement of the capacity presented by the silicon of these structures to retain hydrogen has been carried out. In the same way, no study on the effect of the porous morphology at the nano-scale on the storage capacity has been conducted. This capacity to store hydrogen is not a priori dependent on the nature of the acid used. This subject can be referred to in the following documents:
“Chemical composition of fresh porous silicon” by A. Grosman et al., in “Properties of porous silicon,” edited by L. Canham, INSPEC, London, United Kingdom, 1997, pages 145 to 153;
“Strong explosive interaction of hydrogenated porous silicon with oxygen at cryogenic temperatures” by D. Kovaler et al., Physical Review Letters, Volume 87, No. 6, August 2001, 068301.

After theoretical evaluations, the authors of these articles arrive at the conclusion that the capacity for storage of hydrogen on such structures is not high.

### SUMMARY OF THE INVENTION

To remedy the disadvantages of prior art, the invention proposes a new hydrogen reservoir whose hydrogen storage capacities per unit volume and unit mass are comparable or better than those of current storage means. The storage may be obtained simply and at atmospheric pressure, which is a guarantee of safety. This reservoir can be manufactured in mass quantity and at low cost by techniques well known in the silicon industry. The manufacture of this reservoir is compatible with the various technologies of construction of fuel cells with various ranges of power.

The invention therefore has for one object a hydrogen reservoir comprising a substance suitable for storing hydrogen, characterised in that said substance is made up of nano-structured silicon.

By nano-structured silicon, we mean a nano-structure presenting a high specific surface (greater than 100 m²/cm³), i.e. a nano-structure that contains nano-crystallites or nano-particles of silicon of various geometric shapes, interconnected or not between themselves, of which at least one dimension is less than or equal to 100 nm and of which the sum of the surface areas of each nano-crystallite and/or nano-particle is greater than the plane surface occupied by the nano-structure.

To best advantage, said substance is made up of meso-porous and/or nano-porous silicon nanostructures.

The initial morphology of the silicon to be nanostructured can be chosen from among monocrystalline silicon, polycrystalline silicon-and amorphous silicon.

According to a particularly advantageous embodiment, the substance is made up of nano-structured, porous and compacted silicon or, to even better advantage, of nano-structured, porous, ground and compacted silicon.

The invention also has for object a process for the manufacture of a hydrogen reservoir, characterised in that it consists in porosifying silicon to produce nano-structures of meso-porous or nano-porous silicon and to store hydrogen in them by creating chemical bonds between the hydrogen and the silicon.

The creation of chemical bonds between the hydrogen and the silicon can be obtained through the action of an acid.

The manufacturing process may consist in subjecting monocrystalline, polycrystalline or amorphous silicon to an electrochemical anodisation implementing an acid and making it possible to simultaneously obtain the porosification of the silicon and the storage of the hydrogen.

The acid implemented may be hydrofluoric acid.

The manufacturing process may further comprise a subsequent step consisting in compacting (i.e. eliminating the empty space between the nano-crystal-lites) the nano-structured silicon. It may also comprise, before the compaction step, a step for grinding of the nano-structured silicon. The grinding step makes it possible to obtain a nano-structured silicon powder.

The invention further has for object a method for use of a hydrogen reservoir as defined above, characterised in that the hydrogen being stored in the reservoir, the method includes a step consisting in causing the breakage of the chemical bonds between the hydrogen and the silicon in order to extract the hydrogen.

The breakage of the chemical bonds between the hydrogen and the silicon can be brought about by an input of energy chosen from among chemical energy, thermal energy, mechanical energy (released, for example, as the consequence of compression), radiant energy and the energy of an electric field.

To best advantage, the method for use includes a step for recharging the reservoir consisting in putting said substance in contact with an acid.

The invention further has for object a fuel cell system, a fuel cell, a hydrogen motor system or a hydrogen motor including such a hydrogen reservoir.

### DETAILED EXPOSITION OF SPECIFIC EMBODIMENTS

Porosification of the mono-crystalline, polycrystalline or amorphous silicon, on the nanometer scale, by electrochemical anodisation, makes possible the creation of nanometer-scale pores resulting in the embrittlement of its initial structure, an embrittlement that is exploited to best advantage by the invention. The size of the nano-crystals obtained and the level of embrittlement of the nano-structured layer are determined as a function of the substrate initially chosen and the anodisation parameters (anodisation current, composition of the electrochemical solution). Two typical morphologies can be obtained which can be designated by the expressions “nano-sponge” and “nano-column.”

This operation for the electrochemical anodisation of the silicon including contact with an acid, for example hydrofluoric acid, makes possible the storage of hydrogen at atmospheric pressure in the form of Si—Hₓ, bonds (x being able to take the values 1, 2 or 3). The effectiveness of this storage reaches experimentally the level of approximately 3 millimoles per cm³ (for nano-columns) without any optimisation of the process. These values can be increased theoretically by a factor of 10, i.e. to reach 30 millimoles per cm³, by using nano-porous silicon (of the nano-sponge type). This is explained by the size of the nano-crystallites, which is approximately 10 times less than that of the nano-crystallites of meso-porous silicon (with equivalent porosity). In other words, this leads to the multiplication by 10 of the specific storage surface and therefore to the multiplication by 10 of the number of hydrogen atoms stored on the silicon atoms located on the surface of the nano-crystallites.

It can be advanced that the size of the nano-crystals for meso-porous silicon is between 7 and 100 nm and that the size of the nano-crystals for nano-porous silicon is between 1 and 7 nm.

Supposing that each silicon atom located on the surface of the nano-crystallites can bind only with one hydrogen atom, it is estimated that the maximum value of the number of moles of hydrogen that can be stored in meso-porous silicon is 12 millimoles per cm³ and in nano-porous silicon it is 120 millimoles per cm³.

The theoretical storage capacity of 120 millimoles per cm³ in nano-porous silicon leads already to values competing with current storage solutions (solid metallic hydrides and methanol) as shown in table I below. However, these storage capacities in meso-porous silicon and in nano-porous silicon can be distinctly improved by their grinding and/or their compaction.

Compaction consists in eliminating the empty space (nano-pores) separating the nano-crystallites by compressing these porous nano-structures. This procedure makes it possible to reduce the volume occupied by the hydrogen-charged silicon while preserving the same mass. The maximum theoretical gain of hydrogen storage capacity per unit volume is given by the relationship 1/(1−P) where P is the initial porosity. For example, for a porosity of 75%, the storage capacity is theoretically multiplied by a factor of 4 after this compaction.

A priori, the compacting procedure is relatively simple and does not require expensive devices.

Grinding consists in breaking the porous nano-structures by crushing them in a controlled manner. It can be carried out, for example, by using apparatus that is commercially available and designed to grind other materials. The inventors of this invention have demonstrated that certain nano-structured morphologies can be very easily ground, even manually by simple sintering between two polished surfaces.

The particle size distribution of the “nano-dust” thus obtained (nano-dust is the condition of the porous nano-structures after grinding) depends on the morphology of the initial porous nano-structure, as well as on the grinding parameters. Moreover, the particle size distribution may be modified if the nano-structures are treated by physico-chemical means before grinding.

The hydrogen storage capacity is then improved by a factor of 1+2(1P) ², where P is the initial porosity. For example, for a porosity of 75%, the storage capacity theoretically increases by 12.5% after grinding.

The grinding operation will be followed by compaction of the nano-dust obtained.

Table 1 groups together the theoretical performance characteristics of the hydrogen reservoir according to the invention as a function of the nano-structures derived from the porous silicon.

TABLE I

| Nano-structures | | | | | |
|---|---|---|---|---|---|
| of the porous | | | Compacted | Compacted | Compacted |
| silicon constituting | Meso-porous | Nano-porous | meso-porous | nano-porous | Silicon |
| the reservoir | silicon | silicon | silicon | silicon | dust |
| THEORETICAL number of | 6 | 60 | 24 | 240 | 270 |
| moles of H₂ per cm³ | mmoles | mmoles | mmoles | mmoles | mmoles |
| ρᵥ(H₂) (kgH₂m⁻³) | 12 | 120 | 48 | 480 | 540 |
| ρₘ(H₂) (% mass) | 2 | 17 | 7.6 | 45 | 48 |

For this table, the calculations were made for a porosity of 75% for all silicon technologies.

Table II compares the theoretical performance characteristics of the hydrogen reservoir according to the invention as a function of the nano-structures derived from the porous silicon used with respect to the storage means of the art known in the fuel cell application.

TABLE II

| | | Available | Available |
|---|---|---|---|
| | | energy per | energy per |
| | | volume | mass |
| | Technology | (Wh/l) | (Wh/kg) |
| Invention | Meso-porous | 475 | 800 |
| | silicon + H₂ | | |
| | Nano-porous | 4760 | 6775 |
| | silicon + H₂ | | |
| | Compacted meso- | 1900 | 3020 |
| | porous silicon + H₂ | | |
| | Compacted nano- | 19040 | 17920 |
| | porous silicon + H₂ | | |
| | Compacted silicon | 21420 | 19080 |
| | nano-dust + H₂ | | |
| Known art | Hydrogen gas | X | 39670 |
| | Liquid hydrogen* | 2500 | 33000 |
| | Solid metallic | 3300 | 370 |
| | hydrides* | | |
| | Carbon nanotubes* | 32000 | 16000 |
| | Methanol* | 4900 | 6200 |

orders of magnitude appearing in the literature (no information on the calculation being available).

For this table, the calculations were made for a porosity of 75% for all silicon technologies. The mass of the packaging of the reservoir is not taken into account.

Upon analysis of this table, it is noted that the nano-porous silicon already offers potentialities comparable to those of the solid metallic hydrides and of methanol. Moreover, it is clear that the compaction procedure considerably improves the potentialities for hydrogen storage, making meso-porous silicon much more interesting and placing nano-porous silicon among the best solutions.

A hydrogen reservoir (outside of packaging) with a base of compacted silicon dust of 34.7 cm³ and 39 g, according to the invention, can theoretically supply a portable telephone consuming 1W for one month.

Extraction of the hydrogen from the reservoir according to the invention, for the purpose of its use, can be obtained by a thermal treatment of the reservoir or a chemical treatment (for example with ethanol). It can also be obtained by application of radiant energy (for example ultra-violet), of an electric field or of mechanical energy (for example compression).

Once emptied by whatever means, the hydrogen reservoir according to the invention may be recharged by simple contact with an acid.

To give an order of magnitude of the potentialities for mass production, it is estimated that it would be necessary to anodise approximately fifty silicon plates of 30 cm diameter, over a 500 μm thickness, to obtain 1 kg of porous silicon nano-structures. This is easily attained in the industrial environment.

1-15. (canceled)

16. A hydrogen reservoir comprising a substance suitable for storing hydrogen, said substance being made up of nano-structured silicon.

17. A hydrogen reservoir as claimed in claim 16, said substance being made up of meso-porous and/or nano-porous silicon nanostructures.

18. A hydrogen reservoir as claimed in claim 16, said substance being made up of nano-structured silicon, porous and compacted.

19. A hydrogen reservoir as claimed in claim 16, said substance being made up of nano-structured silicon, porous, ground and compacted.

20. A manufacturing process for a hydrogen reservoir, comprising porosifying silicon in order to produce meso-porous and/or nano-porous silicon nano-structures and to store hydrogen in the nano-structures by creating chemical bonds between the hydrogen and the silicon.

21. A manufacturing process as claimed in claim 20, wherein the creation of the chemical bonds between the hydrogen and the silicon is obtained through action of an acid.

22. A manufacturing process as claimed in claim 20, comprising subjecting monocrystalline, polycrystalline or amorphous silicon to an electrochemical anodisation implementing an acid and making it possible to simultaneously obtain the porosification of the silicon and the storage of the hydrogen.

23. A manufacturing process as claimed in claim 22, wherein the acid implemented is hydrofluoric acid.

24. A manufacturing process as claimed in claim 20, further comprising a subsequent step comprising compacting the nano-structured silicon.

25. A manufacturing process as claimed in claim 24, further comprising, before the compaction step, a step for grinding of the nano-structured silicon.

26. A method for extracting hydrogen from a hydrogen reservoir as claimed in claim 16, wherein hydrogen is stored in the hydrogen reservoir, the method comprising bringing about the breakage of the chemical bonds between the hydrogen and the silicon in order to extract the hydrogen.

27. A method for extracting hydrogen as claimed in claim 26, wherein the breakage of the chemical bonds between the hydrogen and the silicon is brought about by an input of energy chosen from among chemical energy, thermal energy, mechanical energy, radiant energy and the energy of an electric field.

28. A method for extracting hydrogen as claimed in claim 26, further comprising recharging the hydrogen reservoir by putting said substance in contact with an acid.

29. A fuel cell system or fuel cell including a hydrogen reservoir as claimed in claim 16.

30. A hydrogen motor system or hydrogen motor including a hydrogen reservoir as claimed in claim 16.
